(19) United States
(12) Patent Application Publication
(10) Pub. No.: US 2020/0047958 A1
(43) Pub. Date: Feb. 13, 2020

(54) SUNSCREEN CONTAINER SYSTEM

(71) Applicant: Younsil Seo, Richmond Hill ON (CA)

(72) Inventor: Younsil Seo, Richmond Hill ON (CA)

(21) Appl. No.: 16/109,710

(22) Filed: Aug. 22, 2018

(30) Foreign Application Priority Data
Aug. 13, 2018 (CA) 3013980

(51) Int. Cl. B65D 47/42; A45D 40/26; B65D 47/20

(52) U.S. Cl. CPC B65D 47/42; A45D 40/264; A61Q 17/04; A45D 2200/1018; B65D 47/20

(57) ABSTRACT

A sunscreen container system including a storage container having a lid including a first-compartment housing, a dispenser, and a first-compartment-lid, and a second-compartment housing an applicator, a reflective-member, and a second-compartment-lid. The storage container is configured to store a cosmetic product such as sunscreen within an inner volume and dispense the cosmetic product through the dispenser. The storage container is semi-flexible and configured to dispense the cosmetic product when a squeezing-pressure is applied. The reflective-member is positioned on an underside portion of the second-compartment-lid. The applicator is configured to evenly apply the cosmetic product on a surface.

### BACKGROUND OF THE INVENTION

This application claims benefit to which claims benefit under 35 USC 119 to Canada National Application No. 3,013,980 filed on Aug. 13, 2018, the disclosure of which is incorporate herein by reference in its entirety. The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of containers of existing art and more specifically relates to containers and applicators.

### RELATED ART

Sun protection is a burgeoning consideration around the world, and in particular, in Australia. Exposure to short length ultraviolet radiation emitted from the sun is harmful. Prolonged and frequent exposure may lead to sunburn, the development of skin cancers such as basal-cell carcinoma, squamous cell carcinoma and melanoma, premature aging and/or marking of the skin. It has been established that these effects may be amplified from prolonged or frequent exposure to harmful ultraviolet radiation at a young age.

Sunscreen, topically applied, protects skin from harmful UV rays by absorbing or reflecting UV radiation, or a combination of both. It has been established that reapplication at regular intervals is key to maintaining the effectiveness of sunscreen protection, for example, every two to three hours. Sunscreen can be difficult to apply. Also, people, particularly children, may have a skin sensitivity or other issue which requires specific sunscreens to be used. Thus, in situations where a party is applying sunscreen to multiple people, e.g. parents with children, teachers with students, etc., cross-contamination is also an issue. A suitable solution is desired.

U.S. Pub. No. 2016/0015149 to Sung Tae Kim relates to a cosmetic container. The described cosmetic container includes cosmetic vessel including a discharge unit discharging cosmetics to an outside, and a discharge plate provided at one side of the discharge unit from which the cosmetics are discharged, including at least one discharge hole, and formed of a metal of SUS 300 series.

### SUMMARY OF THE INVENTION

In view of the foregoing disadvantages inherent in the known container art, the present disclosure provides a novel sunscreen container system. The general purpose of the present disclosure, which will be described subsequently in greater detail, is to provide an effective and efficient sunscreen container system.

A sunscreen container system is disclosed herein. The sunscreen container system includes a storage container having a lid including a first-compartment housing, a dispenser, and a first-compartment-lid, and a second-compartment housing an applicator, a reflective-member, and a second-compartment-lid. The storage container is configured to store a cosmetic product such as sunscreen within an inner volume and dispense the cosmetic product through the dispenser. The storage container is semi-flexible and configured to dispense the cosmetic product when a squeezing-pressure is applied. The reflective-member is positioned on an underside portion of the second-compartment-lid. The applicator comprises a puff which is configured to evenly apply the cosmetic product on a surface. The puff may include a semi-absorbent sponge material such that the puff does not absorb excessive amounts of the sunscreen or cosmetic product when applying.

According to another embodiment, a kit is also disclosed herein. The kit includes a storage container, lid, and set of user instruction.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a sunscreen container system, constructed and operative according to the teachings of the present disclosure.

FIG. 1 is a perspective view of the sunscreen container system during an ‘in-use’ condition, according to an embodiment of the disclosure.

FIG. 2 is a perspective view of the sunscreen container system of FIG. 1, according to an embodiment of the present disclosure.

FIG. 3 is a perspective view of the sunscreen container system of FIG. 1, according to an embodiment of the present disclosure.

FIG. 4 is a perspective view of the sunscreen container system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a container and lid and more particularly to a sunscreen container system as used to improve the application and storage of cosmetic products while avoiding cross-contamination, in particular sunscreen.

Generally, the sunscreen container system includes a sunscreen-filled container and a lid. The container is equipped with an integrated applicator on the underside of the lid is a reflective surface. The container has a planar bottom surface, a substantially planar side wall surface which is formed to define a bottle, squeeze-tube, or jar, and a planar top surface of an upper lid. The lid of the container includes two parts. A first-part folds open to dispense the sunscreen from the container. The second-part is a compartment that contains an applicator and reflective surface on the underside of the lid. The lid may be removeable and interchangeable between containers.

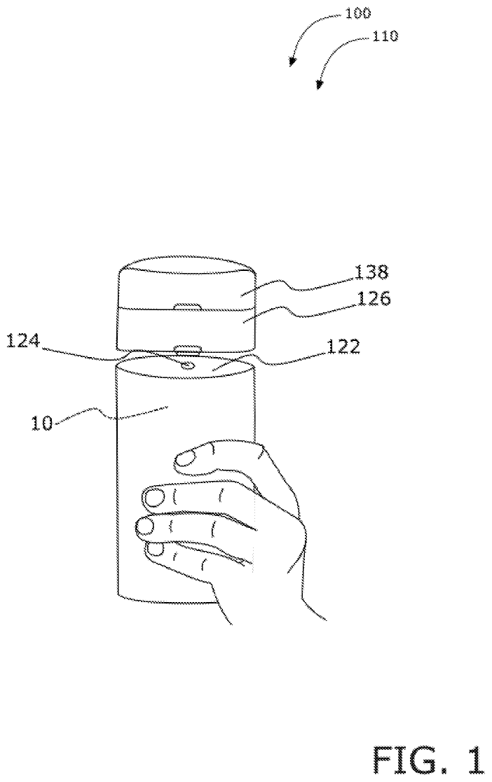

Referring now more specifically to the drawings by numerals of reference, there is shown in FIGS. 1-4, various views of a sunscreen container system 100. FIG. 1 shows a sunscreen container system 100 during an ‘in-use’ condition 150, according to an embodiment of the present disclosure. Here, the sunscreen container system 100 may be beneficial for use by a user to apply sunscreen 10. As illustrated, the sunscreen container system 100 may include a storage container 110 having a lid 120 including a first-compartment 122 housing, a dispenser 124, and a first-compartment-lid 126, and a second-compartment 130 housing an applicator 132, a reflective-member 136, and a second-compartment-lid 138. The storage container 130 is configured to store a cosmetic product 10 such as sunscreen within an inner volume and dispense the cosmetic product 10 through the dispenser 124. The reflective-member 136 is positioned on an underside portion of the second-compartment-lid 130. The reflective-member 136 includes a mirror or the like for user use. The applicator 132 is configured to evenly apply the cosmetic product 10 on a surface. Lid 120 may be coupled to container 110 in such a manner as to be removeable and interchangeable between containers.

According to one embodiment, the sunscreen container system 100 may be arranged as a kit. In particular, the sunscreen container system 100 may further include a set of instructions. The instructions may detail functional relationships in relation to the structure of the sunscreen container system 100 such that the sunscreen container system 100 can be used, maintained, or the like, in a preferred manner.

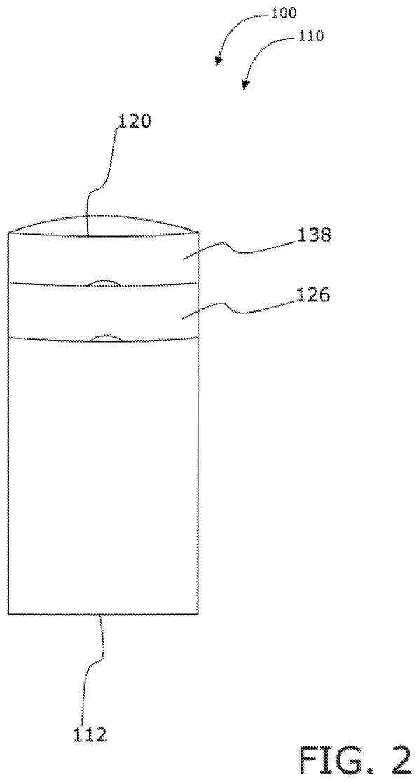

Referring now to FIGS. 2-4 showing various views of the sunscreen container system 100 of FIG. 1, according to an embodiment of the present disclosure. FIG. 2 shows the sunscreen container system 100 of FIG. 1, according to an embodiment of the present disclosure. As above, the sunscreen container system 100 may include the storage container 110 having the lid 120 including the first-compartment 122 housing, the dispenser 124, and the first-compartment-lid 126, and the second-compartment 130 housing the applicator 132, the reflective-member 136, and the second-compartment-lid 138. In a preferred embodiment, a base 112 of the storage container 110 is planar. The storage container 110 includes a planar side wall surface which is formed to define the storage container 110. Further, the lid 120 of the storage container 110 is substantially planar. The storage container 110 is preferably semi-flexible and configured to dispense the cosmetic product 10 when a squeezing-pressure is applied. The storage container 110 may be provided as a bottle, squeeze-tube, jar, or other suitable storage containers 110 for containing sunscreen 10 and the like.

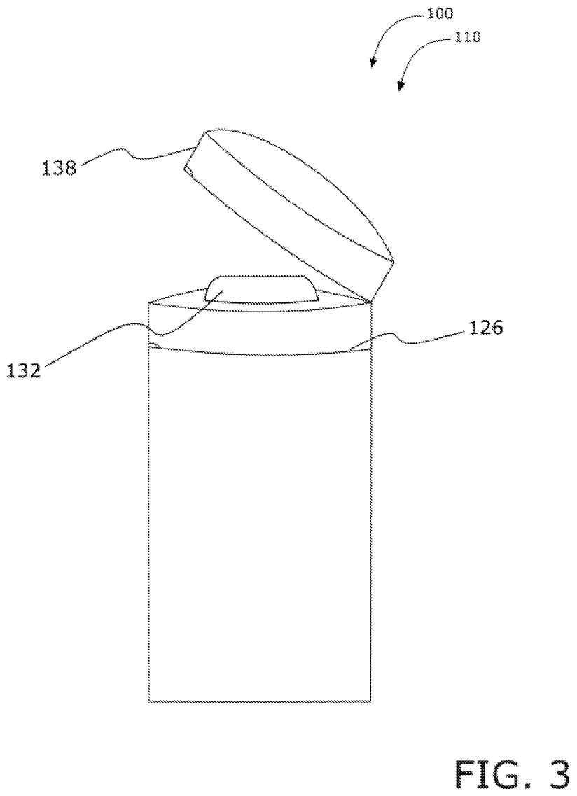

FIG. 3 is a perspective view of the sunscreen container system 100 of FIG. 1, according to an embodiment of the present disclosure. The sunscreen container system 100 includes the storage container 110 and lid 120 in functional combination to provide a sunscreen dispensing device with an integrated applicator 132 and reflective-member 136. The dispenser 124 of the first-compartment 122 dispenses the cosmetic product 10 when the first-compartment-lid 126 is opened and the squeezing-pressure is applied. The first-compartment-lid 126 and the second-compartment-lid 138 are hinged and configured to open and alternatively close. The lid 120 is a single unit having the first-compartment 122 and the second-compartment 130. The first-compartment 122 and the second-compartment 130 are separately accessible. The lid 120 is connected to and positioned at a top-end of the storage container 110. The second-compartment 130 is configured at a top-most portion of the lid 120. The first-compartment 122 is proximal to the top-end of the storage container 110. The dispenser 124 of the first-compartment 122 is in communication with the storage container 110 allowing the cosmetic product 10 to flow through the dispenser 124. The dispenser 124 comprises an aperture.

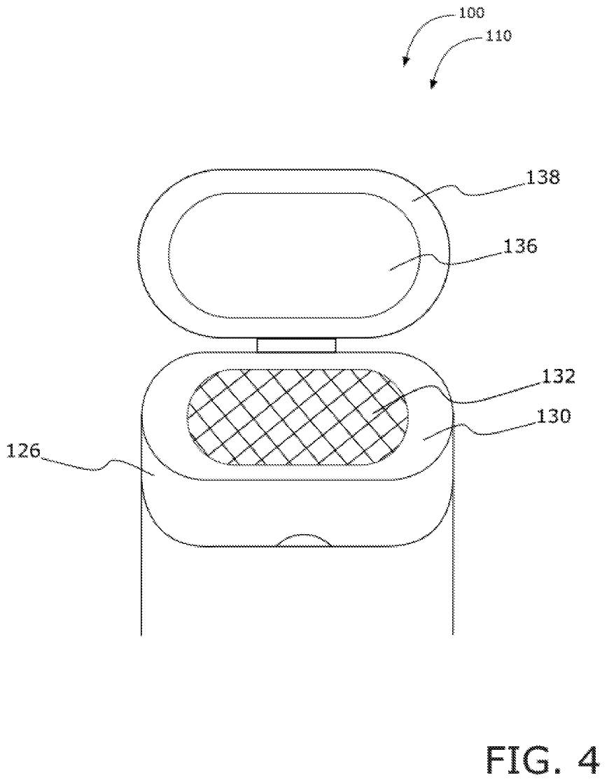

FIG. 4 is another perspective view of the sunscreen container system 100 of FIG. 1, according to an embodiment of the present disclosure. As above, the sunscreen container system 100 may include the storage container 110 having the lid 120 including the first-compartment 122 housing, the dispenser 124, and the first-compartment-lid 126, and the second-compartment 130 housing the applicator 132, the reflective-member 136, and the second-compartment-lid 138. The applicator 132 comprises a puff. The puff includes and is made by slicing an open-cell sponge. The open-cell sponge is semi-absorbent such that it does not absorb excessive amounts of the sunscreen or cosmetic product 10 when applying. Further, the applicator 132 is removably secured within the second compartment lid 138 so as not to rattle or otherwise make sounds during use and transport. The applicator 132 does not easily wrinkle and provides an efficient means for applying sunscreen and other topical/cosmetic products 10 without risk of cross-contamination from the user's fingers. Additionally, applicator 132 may prevent discoloration of the fingers from cosmetic products that are tinted or colored, as well as reducing the need for the user to wash or rinse their hands after application.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A sunscreen container system comprising:
a storage container having;
a lid including;
a first-compartment housing;
a dispenser; and
a first-compartment-lid; and
a second-compartment housing;
an applicator;
a reflective-member; and
a second-compartment-lid;
wherein said storage container is configured to store a cosmetic product within an inner volume and dispense said cosmetic product through said dispenser;
wherein said reflective-member is positioned on an underside portion of said second-compartment-lid; and
wherein said applicator is configured to evenly apply said cosmetic product on a surface.

2. The sunscreen container system of claim 1, wherein said cosmetic product includes sunscreen.

3. The sunscreen container system of claim 1, wherein a base of said storage container is planar.

4. The sunscreen container system of claim 3, wherein said storage container includes a planar side wall surface which is formed to define said storage container.

5. The sunscreen container system of claim 4, wherein said lid of said storage container is substantially planar.

6. The sunscreen container system of claim 1, wherein said storage container is semi-flexible and configured to dispense said cosmetic product when a squeezing-pressure is applied.

7. The sunscreen container system of claim 6, wherein said dispenser of said first-compartment dispenses said cosmetic product when said first-compartment-lid is opened and said squeezing-pressure is applied.

8. The sunscreen container system of claim 1, wherein said first-compartment-lid and said second-compartment-lid are hinged and configured to open and alternatively close.

9. The sunscreen container system of claim 1, wherein said lid is a single unit having said first-compartment and said second-compartment, said first-compartment and said second-compartment are separately accessible.

10. The sunscreen container system of claim 1, wherein said lid is connected to and positioned at a top-end of said storage container.

11. The sunscreen container system of claim 10, wherein said first-compartment is proximal to said top-end of said storage container.

12. The sunscreen container system of claim 11, wherein said dispenser of said first-compartment is in communication with said storage container allowing said cosmetic product to flow through said dispenser.

13. The sunscreen container system of claim 12, wherein said dispenser comprises an aperture.

14. The sunscreen container system of claim 1, wherein said applicator comprises a puff

15. The sunscreen container system of claim 15, wherein said puff includes a slice sheet of an open-cell sponge.

16. The sunscreen container system of claim 16, wherein said open-cell sponge is semi-absorbent.

17. The sunscreen container system of claim 1, wherein said second-compartment is configured at a top-most portion of said lid.

18. The sunscreen container system of claim 1, wherein said reflective-member is a mirror.

19. A sunscreen container system, the sunscreen container system comprising:
a storage container having;
a lid including;
a first-compartment housing;
a dispenser; and
a first-compartment-lid; and
a second-compartment housing;
an applicator;
a reflective-member; and
a second-compartment-lid;
wherein said storage container is configured to store a cosmetic product within an inner volume and dispense said cosmetic product through said dispenser;
wherein said reflective-member is positioned on an underside portion of said second-compartment-lid; and
wherein said applicator is configured to evenly apply said cosmetic product on a surface;
wherein said cosmetic product includes sunscreen;
wherein a base of said storage container is planar;
wherein said storage container includes a planar side wall surface which is formed to define said storage container;
wherein said lid of said storage container is substantially planar;
wherein said storage container is semi-flexible and configured to dispense said cosmetic product when a squeezing-pressure is applied;
wherein said dispenser of said first-compartment dispenses said cosmetic product when said first-compartment-lid is opened and said squeezing-pressure is applied;
wherein said first-compartment-lid and said second-compartment-lid are hinged and configured to open and alternatively close;
wherein said lid is a single unit having said first-compartment and said second-compartment, said first-compartment and said second-compartment are separately accessible;
wherein said lid is connected to and positioned at a top-end of said storage container;
wherein said second-compartment is configured at a top-most portion of said lid;
wherein said first-compartment is proximal to said top-end of said storage container;
wherein said dispenser of said first-compartment is in communication with said storage container allowing said cosmetic product to flow through said dispenser;
wherein said dispenser comprises an aperture;
wherein said applicator comprises a puff;
wherein said puff includes a slice sheet of an open-cell sponge;
wherein said open-cell sponge is semi-absorbent; and
wherein said reflective-member is a mirror.

20. The sunscreen container system of claim 19, further comprising set of instructions; and
wherein the sunscreen container system is arranged as a kit.
